(19) United States
(12) Patent Application Publication
(10) Pub. No.: US 2002/0038502 A1
(43) Pub. Date: Apr. 4, 2002

(54) Glove mounting device

(76) Inventor: Andrew J. Valentine, Hilliard, OH (US)

Correspondence Address: Porter, Wright, Morris & Arthur LLP, ATTN: Intellectual Property Department, 28th Floor, 41 South High Street, Columbus, OH, 43215-6194, US

(21) Appl. No.: 09/964,961

(22) Filed: Sep. 27, 2001

Related U.S. Application Data
(60) Provisional application No. 60/237,921, filed on Oct. 4, 2000.

(51) Int. Cl. B23P 19/00

(52) U.S. Cl. 29/456

(57) ABSTRACT

A glove mounting device is provided that includes an inner collar, an outer collar, and means for removably attaching the inner and outer collars. The inner and outer collars are adapted to form a seal between a sleeve of a glove and a surface of a structure when the collars are attached with the sleeve of the glove and a portion of the structure in between said collars. The seal formed by the glove mounting device between the glove and the structure mounts the glove mounting device to the structure and mounts the glove to the glove mounting device. The inner collar and the outer collar are rings, and the means for attaching the collars are mating threads on the inner ring and the outer ring. The inner and outer rings include opposing surfaces for forming the seal between the sleeve of a glove and the enclosure using a compressive force occurring when the inner and outer rings are attached. The outer ring includes recesses for accepting a tool designed to assist in attaching the inner and outer rings.

### FEDERALLY-SPONSORED RESEARCH

This invention was made with government support under Contract No. SPO 900-94-D-0002 awarded by the U.S. Army Medical Research and Material Command. The United States Government has certain rights in this invention.

### RELATED APPLICATION

This application claims the benefit of U.S. provisional patent application No. 60/237,921, filed Oct. 4, 2000.

### BACKGROUND OF THE INVENTION

1. Field of Invention

This invention pertains to glove ports and, more specifically, to removable glove ports.

2. Description of the Related Art

Glove boxes and glove ports are used in research, industry, medicine and other fields. A glove box maintains an isolated environment within an enclosure. A glove sealed from the interior environment extends through a port in the glove box for hand manipulation of objects within the isolated interior of the enclosed structure.

In a conventional glove box, rubber gloves are usually provided projecting into the glove box with the sleeve ends sealed around an opening in a wall of the enclosure. The seals on such glove ports are usually accomplished using an O-ring or gasket around the glove.

### SUMMARY OF THE INVENTION

In accordance with the present invention, a glove mounting device is provided (1) for mounting a glove into an enclosed structure having an opening for the device and (2) for forming a seal between the glove and the enclosure so as to isolate the interior of the structure from elements exterior to the structure.

According to one aspect of the present invention, a glove mounting device is provided having an inner collar, an outer collar, and means for removably attaching the inner and outer collars. The inner and outer collars are adapted to form a seal between a sleeve of a glove and a surface of a structure when the collars are attached with the sleeve of the glove and a portion of the structure in between the collars, thereby mounting the glove mounting device to the structure and mounting the glove to the glove mounting device.

According to another aspect of the present invention, a glove mounting device is provided having an inner collar, an outer collar, and means for removably attaching the inner and outer collars wherein the inner and outer collars include opposing surfaces for forming a seal between the sleeve of a glove and a structure using a compressive force occurring when the inner and outer collars are attached.

The inner collar may include a channel in a surface facing the outer collar for accepting a bead on the sleeve of a glove.

The inner collar and the outer collars of the glove mounting device may be rings, and may include mating threads on the inner ring and the outer ring for attaching the rings together. Preferably, the pitch of the mating threads is equal to or between 8 to 12 threads per inch. The outer ring may include recesses for accepting a tool designed to assist in attaching the inner and outer rings or may include turning aids for assisting in attaching the inner and outer rings. The collars may also be attached using fasteners such as snaps or bolts.

The rings of the glove mounting device may be made from Noryl, PVC, metal, or a metal alloy.

In yet another aspect of the invention, a method of assembling a glove mounting device with a glove and an enclosure having a glove port opening is provided. The method includes providing a glove mounting device having an inner collar, an outer collar, and means for removably attaching the inner and outer collars. The inner and outer collars are adapted to form a seal between a sleeve of a glove and a surface of a structure when the collars are attached with the sleeve of the glove and a portion of the structure in between the collars, thereby mounting the glove mounting device to the structure and mounting the glove to the glove mounting device. The inner and outer collars of the glove mounting device are preferably rings, with both rings preferably having mating threads. The method further includes placing the sleeve of the glove on a surface of the inner collar; placing the inner ring in the glove port opening so a portion of the threads on the inner ring are on the outside of the enclosure; and threading the outer ring onto the threads of the inner ring.

The present invention offers numerous advantages. One advantage is that the rings are removable from the enclosure, thereby allowing the rings or the glove to be replaced and allowing multiple types and compositions of gloves to be used. Another advantage of the present invention is that it has a low profile for ease of use with lightweight portable enclosures. Yet another advantage of the present invention is that the glove mounting device is light and strong. A further advantage of the present invention is that it requires few parts and it does not require a gasket or O-ring to form a seal between a glove and an enclosure. Another advantage of the present invention is that it forms an effective seal with commercially-available gloves.

Still other benefits and advantages of the invention will become apparent to those skilled in the art to which it pertains upon a reading and understanding of the following detailed specification.

### BRIEF DESCRIPTION OF THE DRAWINGS

FIG. 1 is a perspective view of a glove mounting device according to the present invention.

FIG. 2 is a side view of a glove mounting device according to the present invention.

FIG. 3 is a bottom view of a glove mounting device according to the present invention.

FIG. 4 is a cross section of the glove mounting device of FIG. 3 taken along line A-A.

FIG. 5 is an enlarged view of the left side of the cross section of the glove mounting device shown in FIG. 4.

FIG. 5A illustrates the cross section of the glove mounting device shown in FIG. 5 assembled with a glove and an enclosure.

FIG. 6 is an alternative embodiment having handle means on the outer ring of the glove mounting device.

It should be understood that the appended drawings are not necessarily to scale, presenting a somewhat simplified representation of various preferred features illustrative of the basic principles of the invention.

### DESCRIPTION OF THE PREFERRED EMBODIMENT

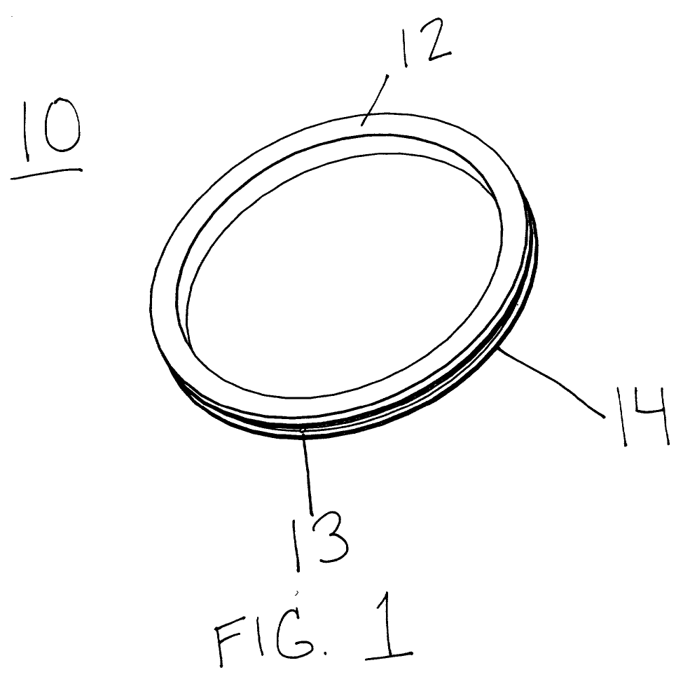

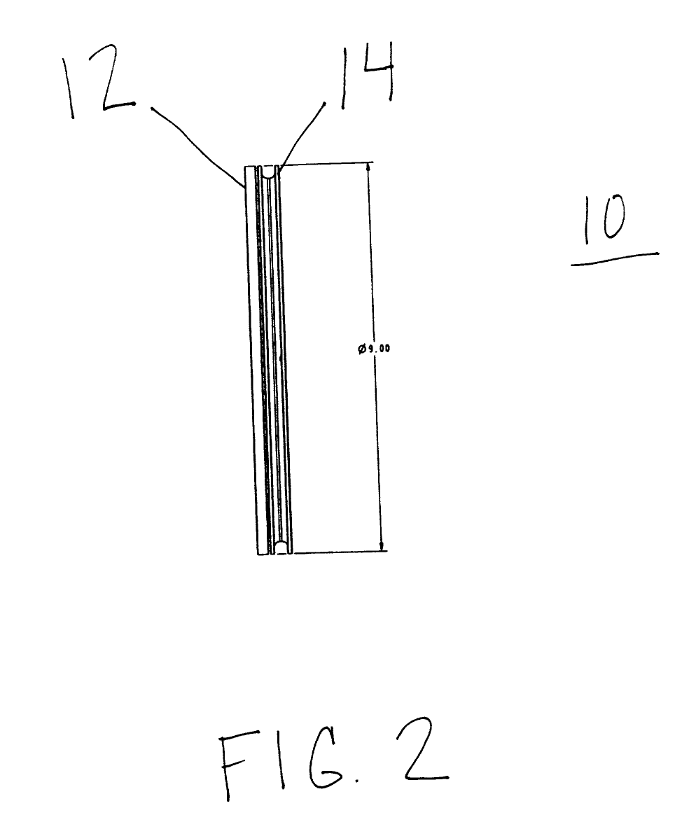

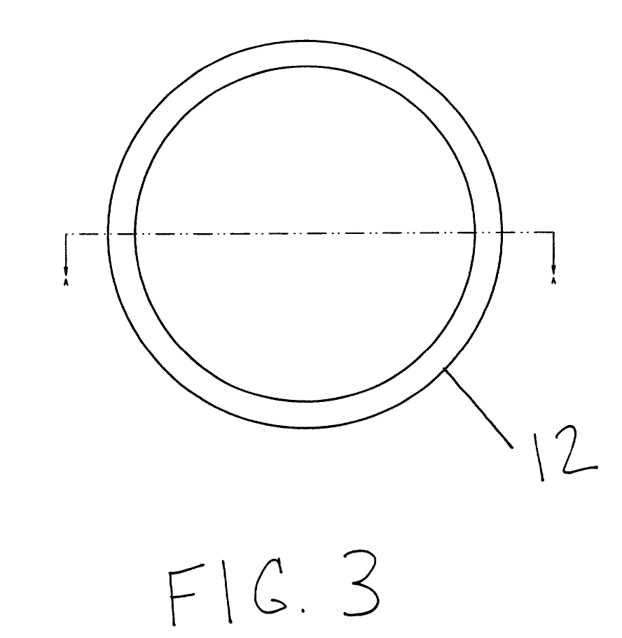

As illustrated in FIGS. 1-5, a glove mounting device 10 is provided for mounting a glove into an enclosed structure having an opening for the device 10 and forming a seal between the glove and the enclosure so as to isolate the interior of the structure from elements exterior to the structure. The glove mounting device 10 accommodates commercially-available protective gloves such as those made from butyl or nitrile rubber. While the illustrated embodiments of the present invention are particularly adapted for use in a biologically and chemically protective system, it is noted that the present invention can be used with any other type of closed or open structure. Other embodiments and design variations will be apparent to those skilled in the art given the benefit of this disclosure.

As illustrated in FIG. 1, the preferred embodiment includes an inner collar 12 and an outer collar 14. The inner collar 12 and the outer collar 14 are rings in the preferred embodiment of the invention, but those skilled in the art will recognize that collars of other shapes are also included within the scope of the invention. It is preferable that the rings 12, 14 are made from a material that is strong, lightweight, resistant to environmental conditions and mechanical damage, and is stiff enough to avoid deformation which would result in loss of seal but is not brittle. In the preferred embodiment, the rings 12, 14 are made from Noryl® resin. However, it is noted that other machinable or moldable materials may be used such as, for example, PVC, metal, or a metal alloy. The specific material used for the collars 12, 14 will depend upon the requirements of the enclosure system. For example, Noryl® is used in the preferred embodiment because it is resistant to biological and chemical contaminants and decontamination or disinfection agents such as chlorine and iodine bearing compositions.

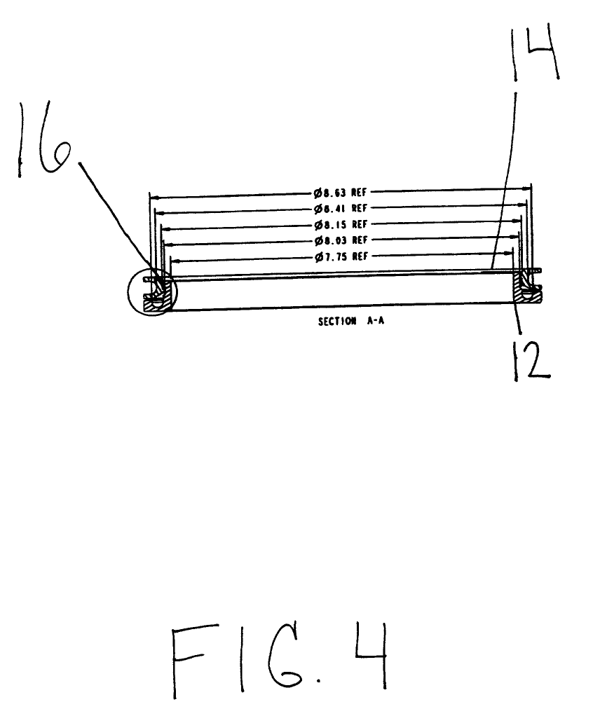

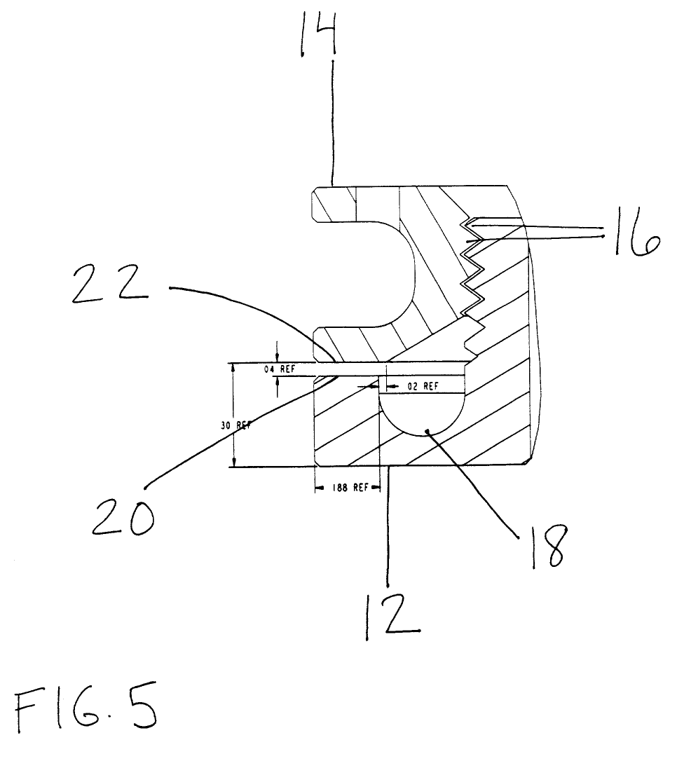

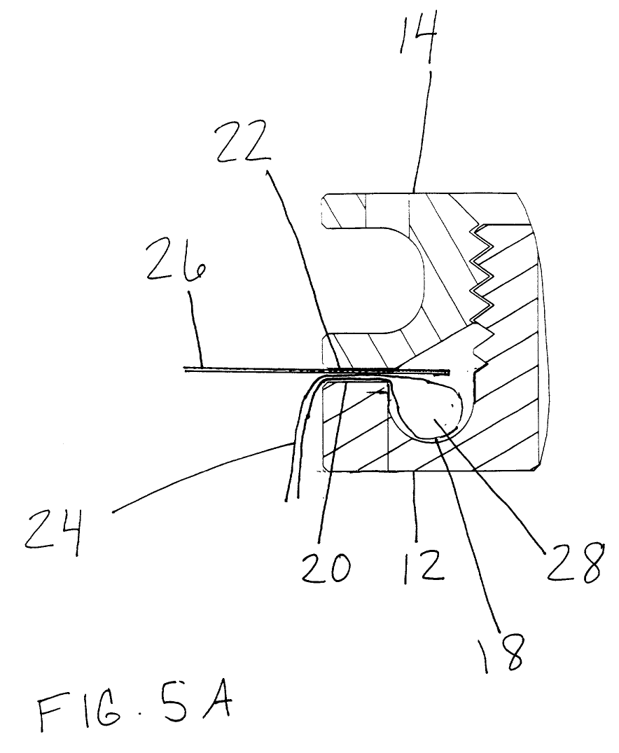

Means for removably attaching the inner collar 12 and the outer collar 14 are provided. In the preferred embodiment, the means for removably attaching the inner ring 12 and the outer ring 14 are mating threads 16 located on opposing portions of the rings 12, 14, as illustrated in FIGS. 4 and 5. The pitch of the mating threads 16 is preferably equal to or between 8 to 12 threads per inch to allow for easy threading, even by a gloved user, and avoid cross-threading. Other means for attaching the inner collar 12 and the outer collar 14 such as, for example, bolts or snaps, are included in the invention.

In the preferred embodiment, the glove mounting device 10 is designed to be mounted, along with a glove, in an opening of a structure such as a biologically and chemically protective enclosure system. The glove mounting device 10 accomplishes mounting of a glove, mounting of the device 10 into an enclosure, and formation of a seal between the glove and the enclosure preferably using one design. As illustrated in FIG. 5, this preferable design is accomplished by the inner ring 12 and outer ring 14 having opposing faces 20 and 22, respectively, that provide a compressive force when the inner and outer rings 12, 14 are attached using the threads 16. A seal is formed in the preferred embodiment between the glove and the enclosure when the rings 12, 14 are attached with portions of the glove and the enclosure placed between the opposing surfaces 20, 22 of the rings 12, 14. The compressive force caused by the opposing surfaces 20, 22 creates the seal between the glove and the enclosure, mounts the glove in place, and mounts the glove mounting device 10 to the enclosure.

In the preferred embodiment, the glove mounting device 10 is designed to allow a sleeve end of a glove to be placed over the surface 20 of the inner ring 12. The inner ring 12 may have a channel 18 in a surface facing the outer ring 14 for accepting a bead, or enlarged end portion, of the sleeve of a glove. The glove mounting device 10 is also preferably designed to allow a portion of the enclosure around an opening in the enclosure to fit in between the glove and the opposing surface 22 of the outer ring 14. This design allows a seal to be formed, the glove to mounted, and the glove mounting device 10 to be mounted to the enclosure when the rings 12, 14 are attached. The glove mounting device 10 may be used for forming seals on gloves with or without a bead on the end of the sleeve. In an alternative embodiment, the seal may be formed with a bead on the sleeve of a glove having such a bead. However, it is preferred to form the seal with the sleeve of the glove because of thickness irregularities in commercially-available gloves and the reduced seal area available when sealing on such beads.

FIG. 5A illustrates the position of a glove 24 and an enclosure 26 in relation to the opposing surfaces 20,22 when the glove mounting device is used to mount a glove 24 in an enclosure 26. The inner ring 12 is within the enclosure 26. The bead 28 of a glove 24 is in the channel 18 and hangs over the opposing surface 20 into the inside of the enclosure 26. A portion of the enclosure 26 forming an opening for the glove mounting device 10 separates the glove 24 and the opposing surface 22 of the outer ring 14. The outer ring 14 is on the outside of the enclosure 26.

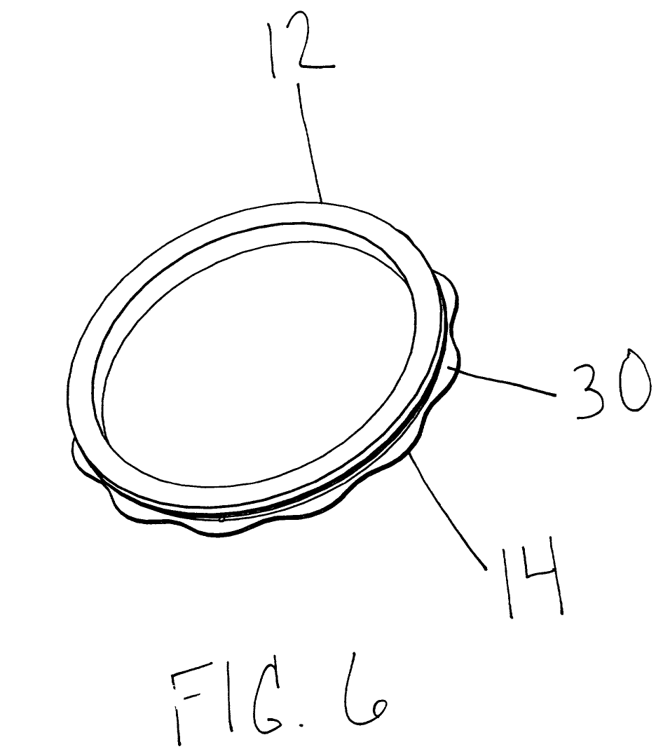

A method of assembling the preferred embodiment described herein with a glove and an enclosure having an opening accommodating the glove mounting device 10 first involves placing the sleeve of the glove over a surface 20 of the inner ring 12. As discussed above, the inner ring 12 may include a channel 18 in the inner ring 12 for accepting a bead on the end of the sleeve of gloves having such beads. Next, the assembled glove/inner ring 12 is placed inside the enclosure, preferably with the thumb of the glove aligned to its desired location. The assembled glove/inner ring 12 is then moved into the opening in the structure so that at least some of the threads 16 on the inner ring 12 are on the outside of the enclosure. The outer ring 14 is threaded onto the threads of the inner ring 12 and the outer ring 14 is screwed onto the inner ring 12 to form a seal between the glove and the enclosure. In the preferred embodiment shown in FIGS. 1-5, the outer ring 14 has two recesses 13 for accepting a tool designed to assist in screwing the outer ring 14 onto the inner ring 12. In an alternative embodiment shown in FIG. 6, the outer ring 14 includes turning aids 30 for assisting in tightening the outer ring 14 onto the inner ring 12.

If desired, a compatible lubricating agent such as silicone grease may be used to improve the seal between the rings and the enclosure and assist in turning the ring against the enclosure.

From the foregoing disclosure and detailed description of certain preferred embodiments, it will be apparent that various modifications, additions and other alternative embodiments are possible without departing from the true scope and spirit of the present invention. For example, it will be apparent to those skilled in the art, given the benefit of the present disclosure, that the invention discussed herein in connection with a chemically and biologically protective enclosure system, can be used with any other enclosed or open structure and varying types of gloves. The embodiments discussed were chosen and described to provide the best illustration of the principles of the present invention and its practical application to thereby enable one of ordinary skill in the art to use the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

The following is claimed:

1. A glove mounting device comprising:
an inner collar;
an outer collar; and
means for removably attaching said inner and outer collars;
said inner and outer collars being adapted to form a seal between a sleeve of a glove and a surface of a structure when said collars are attached with the sleeve of the glove and a portion of the structure in between said collars, thereby mounting said glove mounting device to said structure and mounting said glove to said glove mounting device.

2. The glove mounting device of claim 1 wherein said inner and outer collars include opposing surfaces for forming a seal between the sleeve of a glove and a structure using a compressive force occurring when said inner and outer collars are attached.

3. The glove mounting device of claim 1 wherein said inner collar and said outer collar are rings.

4. The glove mounting device of claim 3 wherein the means for attaching the collars are mating threads on said inner ring and said outer ring.

5. The glove mounting device of claim 1 wherein the means for attaching the collars are snaps.

6. The glove mounting device of claim 1 wherein the means for attaching the collars are bolts.

7. The glove mounting device of claim 4 wherein the pitch of the mating threads is equal to or between 8 to 12 threads per inch.

8. The glove mounting device of claim 1 wherein said inner collar includes a channel in a surface facing the outer collar for accepting a bead on the sleeve of a glove.

9. The glove mounting device of claim 4 wherein said outer ring includes recesses for accepting a tool designed for assisting in attaching said inner and outer rings.

10. The glove mounting device of claim 4 wherein said outer ring includes turning aids for assisting in attaching said inner and outer rings.

11. The glove mounting device of claim 4 wherein:
the pitch of the mating threads is between 8 to 12 threads per inch;
said inner and outer rings include opposing surfaces for forming a seal between the sleeve of a glove and a structure using a compressive force occurring when said inner and outer rings are attached; and
said outer ring includes two holes for accepting a tool designed to attach said inner and outer rings.

12. The glove mounting device of claim 11 wherein the inner ring includes a channel in a surface facing the outer ring for accepting a bead on the sleeve of a glove.

13. The glove mounting device of claim 11 wherein said rings are made from Noryl.

14. The glove mounting device of claim 11 wherein said rings are made from PVC.

15. The glove mounting device of claim 11 wherein said rings are made from metal.

16. A method of assembling a glove mounting device with a glove and an enclosure having a glove port opening comprising the steps of:.
(a) providing a glove mounting device comprising:
an inner collar;
an outer collar; and
means for removably attaching said inner and outer collars;
said inner and outer collars being adapted to form a seal between a sleeve of a glove and a surface of an enclosure when said collars are attached with the sleeve of the glove and a portion of the structure in between said collars, thereby mounting said glove mounting device to said structure and mounting said glove to said glove mounting device;
wherein said inner collar and said outer collar are rings and the means for attaching the collars are mating threads on said inner ring and said outer ring;
(b) placing the sleeve of the glove on a surface of the inner collar;
(c) placing the inner ring in the glove port opening so that a portion of the threads on the inner ring are on the outside of the enclosure; and
(d) threading the outer ring onto the threads of the inner ring.

17. The method of claim 16 wherein said inner collar includes a channel in a surface facing the outer collar for accepting a bead on the sleeve of a glove and wherein the method further comprises the step of placing the bead of the glove in the channel of the inner ring.
